(19) United States
(12) Patent Application Publication
(10) Pub. No.: US 2021/0178412 A1
(43) Pub. Date: Jun. 17, 2021

(54) COATING PRODUCTION DEVICE

(71) Applicant: Kao Corporation, Tokyo (JP)

(72) Inventors: Takuya ISHIDA, Tochigi (JP); Ikuo FUKUDA, Tochigi (JP); Takahiro HIRANO, Tochigi (JP); Takehiko TOJO, Tochigi (JP)

(73) Assignee: Kao Corporation, Tokyo (JP)

(21) Appl. No.: 17/268,797

(22) PCT Filed: Oct. 3, 2019
(86) PCT No.: PCT/JP2019/039078

§ 371 Date: Feb. 16, 2021

(30) Foreign Application Priority Data
Oct. 3, 2018 (JP) 2018-188681

(51) Int. Cl. B05B 5/025; B05D 1/04; D01D 5/00; D04H 1/728

(52) U.S. Cl. CPC B05B 5/025; D04H 1/728; D01D 5/0007; B05D 1/04

(57) ABSTRACT

The present invention provides an apparatus with which it is possible to easily form a coating made of deposits of fibers. Specifically, the present invention provides an apparatus (1) for producing a coating that includes an electrostatic spraying section (P1) that includes a housing (10). The housing (10) is internally provided with a nozzle (16), an electrode (20), an air-flow generating section (21), a hollow section (22), and an air jetting opening (24). The hollow section (22) is located between the nozzle (16) and the air-flow generating section (21) and is adjacent to the air-flow generating section (21). The hollow section (22) is adjacent to the air jetting opening (24). The housing (10) is configured to be capable of being held by a human hand. When the electrostatic spraying section (P1) is viewed in a liquid composition discharge direction, a tip of the nozzle (16) is located at a frontmost end portion of the electrostatic spraying section (P1).

### TECHNICAL FIELD

The present invention relates to an apparatus for producing a coating that is made of deposits of fibers.

### BACKGROUND ART

As a conventional technique for forming a coating by spinning fibers using an electrostatically spraying method, for example, the technique disclosed in Patent Literature 1 is known. Patent Literature 1 discloses an electrospinning apparatus that produces a coating from a liquefied polymer, wherein the electrospinning apparatus is configured such that a dispenser for dispensing the liquefied polymer and an annular electrode are provided in a hollow section so as to allow polymer fibers formed from the liquefied polymer to move through the hollow section. The hollow section has openings on the front side and the rear side, and a blower is provided in the rear opening. The polymer fibers are conveyed as a result of an air flow generated by the blower moving through the hollow section, and thereby the polymer fibers are forced out of the hollow section through the front opening.

### CITATION LIST

### Patent Literature

Patent Literature 1: JP 2004-525272A

### SUMMARY OF INVENTION

The present invention provides an apparatus configured to electrostatically spray a liquid composition that contains a fiber-forming polymer directly to a surface of an object so as to form a coating made of deposits of fibers on the surface of the object.

The apparatus preferably includes an electrostatic spraying section that includes a housing.

The housing is preferably internally provided with a nozzle that discharges the liquid composition.

The housing is preferably internally provided with an electrode that applies voltage to the liquid composition that passes through the nozzle.

The housing is preferably internally provided with an air-flow generating section that is located on a rear side of the nozzle.

The housing is preferably internally provided with a hollow section that is located between the nozzle and the air-flow generating section and is adjacent to the air-flow generating section.

The housing is preferably internally provided with an air jetting opening that is located around the nozzle and jets an air flow that has passed through the hollow section.

The housing is preferably configured to be capable of being held by a human hand.

Also, the present invention relates to a method for producing a coating, the method including: with use of the above-described apparatus for producing a coating, electrostatically spraying a liquid composition that contains a fiber-forming polymer directly to a surface of an object while jetting an air flow from the air jetting opening so as to form a coating made of deposits of fibers on the surface of the object.

### BRIEF DESCRIPTION OF DRAWINGS

FIG. 1 is a schematic diagram showing an embodiment of an apparatus for producing a coating according to the present invention.

FIG. 2 is a schematic diagram showing another embodiment of the apparatus for producing a coating according to the present invention.

### DESCRIPTION OF EMBODIMENT

With the technique disclosed in Patent Literature 1 described above, the polymer fibers that are formed from the liquefied polymer dispensed from the dispenser move through the hollow section, pass through the annular electrode provided in the hollow section, and then are forced out of the hollow section. Due to the polymer fibers moving through the hollow section, the polymer fibers are likely to adhere to the inner wall of the hollow section. Accordingly, depending on the situation, the hollow section may be clogged by the polymer fibers. As a result, with the technique disclosed in Patent Literature 1, it is not easy to successfully form an intended coating.

The present invention relates to an improvement in an apparatus for forming a coating using an electrostatically spraying method.

Hereinafter, the present invention will be described by way of preferred embodiments thereof with reference to the drawings. The present invention relates to an apparatus configured to apply a liquid composition that contains a fiber-forming polymer directly to a surface of an object so as to form a coating made of deposits of fibers on the surface of the object. As a method for forming a coating, an electrostatically spraying method is used in the present invention. The electrostatically spraying method is a method in which a positive or negative high voltage is applied to a liquid composition to electrically charge the composition, and the electrically charged composition is jetted toward an object. The jetted liquid composition diffuses into the air while it is repeatedly formed into fine fibers due to Coulomb repulsion. During this process or after the jetted liquid composition adheres to the object, a solvent that is a volatile substance dries, and a coating composed of deposits of fibers is thereby formed on the surface of the object. Accordingly, the electrostatically spraying method by jetting a liquid composition, which is performed by the apparatus of the present invention, is an electrospinning method.

There is no particular limitation on the object on which a coating is formed using the electrostatically spraying method. The coating can be formed on the surface of an object with irregularities, such as, for example, human skin, or a wall, tableware, or the surface of a plant such as a branch or a leaf by causing the coating to adhere to the surface thereof. As used herein, the term “irregularities” encompasses irregularities that can be visually recognized, irregularities that are unlikely to be visually recognized such as sulcus cutis of the skin, and the like. From the viewpoint of providing a coating that is porous and has appropriate water evaporation properties close to the human stratum corneum, the human skin is preferably used as the object, and the body is preferably used as the object.

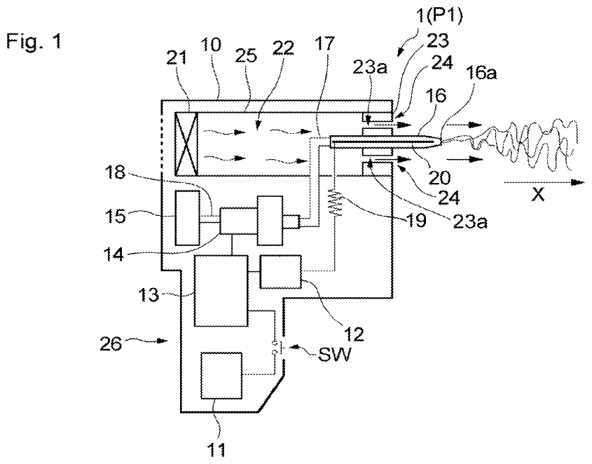

FIG. 1 shows an embodiment of an apparatus for producing a coating according to the present invention. An apparatus 1 shown in the diagram includes an electrostatic spraying section P1 that includes a housing 10 and is provided as an electrospinning apparatus. In the housing 10, a low voltage power supply 11 is provided. The low voltage power supply 11 can generate a voltage in the range of several to several tens of volts (V). For the purpose of enhancing the portability of the apparatus 1, the low voltage power supply 11 is preferably composed of one or two or more batteries. Using batteries as the low voltage power supply 11 is advantageous in that the batteries can be easily replaced as needed. Instead of batteries, it is also possible to use an AC adapter or the like as the low voltage power supply 11.

In the housing 10 of the apparatus 1, a high voltage power supply 12 is also provided. The high voltage power supply 12 is electrically connected to the low voltage power supply 11, and includes an electric circuit (not shown) that boosts the voltage generated by the low voltage power supply 11 to a high voltage. In general, the boost electric circuit is composed of a transformer, a capacitor, a semiconductor device, and the like.

In the housing 10 of the apparatus 1, an auxiliary electric circuit 13 is also provided. The auxiliary electric circuit 13 is provided between the low voltage power supply 11 and the high voltage power supply 12 that were described above, and functions to adjust the voltage of the low voltage power supply 11 and operate the high voltage power supply 12 in a stable manner. Furthermore, the auxiliary electric circuit 13 functions to control the rotation speed of a motor included in a micro gear pump 14, which will be described later. By controlling the rotation speed of the motor, the amount of supply of a liquid composition from a liquid composition container 15, which will be described later, to the micro gear pump 14 is controlled. A switch SW is provided between the auxiliary electric circuit 13 and the low voltage power supply 11, and as a result of the switch SW being turned on or off, the apparatus 1 can be operated or stopped.

In the housing 10 of the apparatus 1, a nozzle 16 is also provided. The nozzle 16 is made of a nonconductive material such as plastic, rubber, or ceramics, and is shaped so as to be capable of discharging the liquid composition from its tip. In the nozzle 16, a microspace through which the liquid composition flows is formed extending along the lengthwise direction of the nozzle 16. It is preferable that the size of a transverse cross section of the microspace, or in other words, the diameter is 100 μm or more and 1000 μm or less. The nozzle 16 is in communication with the micro gear pump 14 via a pipeline 17. In general, the pipeline 17 is made of a nonconductive material. The pipeline 17 causes the liquid composition container 15 and the nozzle 16 to be in communication with each other via the micro gear pump 14.

An electrode 20 is provided in the liquid composition flowing space of the nozzle 16. The electrode 20 is provided to apply voltage to the liquid composition that passes through the nozzle 16 so as to electrically charge the liquid composition. The electrode 20 is composed of a linear body that extends in the liquid composition flow direction. The electrode 20 can have the shape of a wire or a needle. The thickness of the electrode 20 is set to a value that does not prevent the liquid composition from flowing through the nozzle 16. Where a transverse cross sectional area of the liquid composition flowing space of the nozzle 16 is represented by S1, and a transverse cross sectional area of the electrode is represented by S2, it is preferable that S2 is 0.05% or more and 2% or less of S1. In the present invention, the length of the electrode 20 is not critical, and it is sufficient as long as the length is set to such a value that electric charges can be sufficiently applied to the liquid composition that passes through the nozzle 16.

The electrode 20 is made of a conductive material such as a metal. The electrode 20 is electrically connected to the high voltage power supply 12. With this configuration, a high voltage can be applied to the electrode 20. In this case, in order to prevent an excessive current from flowing through a human body if the electrode 20 comes into direct contact with the human body, the electrode 20 and the high voltage power supply 12 are electrically connected via an electric current limiting resistor 19.

The micro gear pump 14 that is in communication with the nozzle 16 via the pipeline 17 functions as a supply apparatus that supplies the liquid composition contained in the container 15 to the nozzle 16. The micro gear pump 14 performs operation in response to supply of power from the low voltage power supply 11. Also, the micro gear pump 14 is configured to supply a predetermined amount of liquid composition to the nozzle 16 under control of the auxiliary electric circuit 13.

The micro gear pump 14 is connected to the container 15 via a pipeline 18. The liquid composition is contained in the container 15. The container 15 is preferably a replaceable cartridge container.

In the housing 10 of the apparatus 1, an air-flow generating section 21 is also provided. The air-flow generating section 21 is located on the rear side of the nozzle 16 in a liquid composition discharge direction (the direction indicated by reference letter X in FIG. 1). The air-flow generating section 21 draws the outside air into the housing 10 and generates an air flow that flows in the liquid composition discharge direction X. To this end, the air-flow generating section 21 may include, for example, a fan or a blower. The air-flow generating section 21 performs operation in response to supply of electricity from the low voltage power supply 11.

A hollow section 22 is located between the nozzle 16 and the air-flow generating section 21. The hollow section 22 is adjacent to the air-flow generating section 21. In addition, the hollow section 22 is also adjacent to the nozzle 16. That is, it is preferable that no member, that extends in a direction perpendicular to an air flow direction and divides the hollow section 22, is provided between the hollow section 22 and the air-flow generating section 21. Likewise, it is preferable that no member, that divides the hollow section 22, is provided between the hollow section 22 and the nozzle 16. The hollow section 22 is preferably composed of a space defined by a cylindrical body 25 that is open at both ends. At one open end of the cylindrical body 25, the air-flow generating section 21 described above is provided. On the other hand, at the other open end of the cylindrical body 25, an air spraying section 23 is provided. The hollow section 22 has the function of temporarily storing the air flow generated in the air-flow generating section 21. To this end, it is desirable that the hollow section 22 has a volume sufficiently large relative to the flow rate of the air flow generated in the air-flow generating section 21. From the viewpoint of enhancing the function of temporarily storing the air flow, which is exhibited by the hollow section 22, it is ideal that the inside of the cylindrical body 25 is completely hollow. However, as long as the above-described effect is not impaired, some kind of member may be provided in the hollow section 22. In the embodiment shown in FIG. 1, a portion of the nozzle 16, a portion of the pipeline 17, and a portion of a circuit that applies voltage to the electrode 20 are present in the hollow section 22.

In the embodiment shown in FIG. 1, the apparatus 1 has one hollow section 22. Instead of providing one hollow section 22, a plurality of hollow sections may be provided. The plurality of hollow sections is composed of a plurality of spaces that are partitioned by a partition member(s) (not shown) and arranged in parallel to the liquid composition discharge direction X. Taking into consideration the fact that the hollow section 22 has the function of temporarily storing the air flow, it is advantageous that the hollow section 22 is composed of one hollow section, from the viewpoint of reliably exhibiting the function of temporarily storing the air flow. It is also possible to provide a plurality of hollow sections composed of a plurality of spaces that are partitioned by a partition member(s) (not shown) and arranged in series in the liquid composition discharge direction X. In the case where a partition member(s) (not shown) as described above is provided, the partition member(s) is preferably provided in parallel to the air flow, from the viewpoint of reducing a pressure loss by rectifying the air flow and from the viewpoint of increasing the amount of air.

The air spraying section 23 provided at the other open end of the cylindrical body 25 is a section that jets the air flow that has passed through the hollow section 22 in the liquid composition discharge direction X. The air spraying section 23 includes one or two or more short flow paths 23a composed of one or two or more through holes that extend in the air flow direction. The air flow is jetted through air jetting openings 24 that are open ends of the short flow paths 23a. The cross sectional area of each of the short flow paths 23a that constitute the air spraying section 23 is constant. Each air jetting opening 24 is configured such that the direction of the air flow jetted from the air jetting opening 24 matches the discharge direction of the liquid composition discharged from the nozzle 16. The air jetting openings 24 are provided to surround the nozzle 16. In the case where a plurality of air jetting openings 24 is provided in the air spraying section 23, it is preferable that the through holes are evenly provided around the nozzle 16 from the viewpoint of jetting the air flow in a stable manner. As shown in FIG. 1, the air spraying section 23 (the short flow paths 23a) and the hollow section 22 are adjacent to each other, and no member is provided therebetween. For example, a pipeline that allows the hollow section 22 and the air spraying section 23 (the short flow paths 23a) to be in communication with each other is not provided between the air spraying section 23 and the hollow section 22.

It is advantageous that the apparatus 1 is shaped to increase the speed of the air flow that passes through the hollow section 22 due to the principle of orifice. To this end, it is advantageous that the air jetting openings 24 located at the end of the cylindrical body 25 that defines the hollow section 22 have an opening area that is smaller than the transverse cross sectional area of the hollow section 22. This region may be referred to as “throttling portion” for throttling the air flow.

The housing 10 that constitutes the apparatus 1 is configured to be capable of being held by a human hand. To be specific, the housing 10 preferably has dimensions and/or a shape that a human can hold with one hand, from the viewpoint of providing good operability. In order for the housing 10 to have “dimensions that a human can hold with one hand”, it is preferable that, for example, the apparatus 1 satisfies any one of the following: the mass of the apparatus 1 is 2 kg or less; maximum length of the housing 10 in the liquid composition discharge direction X is 40 cm or less; and the volume of the housing 10 is 3000 cm³ or less. In order for the housing 10 to have a “shape that a human can hold with one hand”, for example, as shown in FIG. 1, it is preferable that the housing 10 includes a handle 26 that can be held by one human hand. In particular, it is advantageous that the switch SW for causing the apparatus 1 to perform operation is attached to the handle 26 because the operability can be further improved.

For operation of the apparatus 1, the user holds the apparatus 1 with his/her hand so as to direct a tip 16a of the nozzle 16 toward an application site to which electrostatically spraying is performed. In this state, the apparatus 1 is turned on to perform an electrostatically spraying method. In response to the apparatus 1 being turned on, an electric field is generated between the electrode 20 and the application site. For example, in the case where a positive voltage is applied to the electrode, the application site serves as the negative electrode. When an electric field is generated between the electrode 20 and the application site, the liquid composition in the form of droplets discharged from the tip 16a of the nozzle 16 travel through the air along the electric field toward the application site. When a volatile solvent (which will be described later) evaporates from the electrically charged liquid composition traveling through the air, the electric charge density of the liquid composition surface becomes excessive, a fiber-forming polymer diffuses into the air while it is repeatedly formed into fine fibers due to Coulomb repulsion, and reaches the application site. In this case, it is possible to cause the liquid composition to reach the application site in the form of droplets by adjusting the viscosity of the liquid composition as appropriate. Alternatively, a configuration is possible in which, while the liquid composition is discharged into the air, a volatile substance that serves as a solvent is evaporated from the droplets and the fiber-forming polymer that is a solute is solidified, and at the same time, the liquid composition is stretched and deformed due to a potential difference to form fibers, and the fibers are deposited on the application site. For example, by increasing the viscosity of the liquid composition, the liquid composition is likely to be deposited on the application site in the form of fibers. In the manner described above, a porous coating made of fiber deposits is formed on the surface of the application site. The porous coating made of fiber deposits can also be formed by adjusting the distance between the nozzle 16 and the application site or the voltage applied to the nozzle 16.

In the apparatus 1 according to the present embodiment, during discharge of the liquid composition from the nozzle 16, an air flow is generated in the air-flow generating section 21, and the liquid composition is conveyed by the air flow. With this configuration, during formation of a coating, there is little influence of the surrounding environment in which the apparatus 1 is used, and thus a coating of uniform quality can be formed irrespective of the surrounding environment. In particular, it is possible to form a coating of uniform quality irrespective of changes in humidity.

In the electrostatically spraying method, as a conventional technique for conveying a discharge product using an air flow, the technique disclosed in Patent Literature 1 described above is known. However, according to the technique disclosed in Patent Literature 1, the hollow section and the electrode are provided on the front side of the tip of the nozzle. Accordingly, the discharge product discharged from the nozzle is likely to adhere to the inner wall of the hollow section and the electrode, and for this reason, it is not easy to successfully form a coating of intended quality. In contrast, with the apparatus 1 according to the present embodiment, the electrode 20 and the hollow section 22 are provided on the rear side of the tip 16a of the nozzle 16, or in other words, the tip 16a of the nozzle 16 is located at the frontmost end portion of the electrostatic spraying section P1 when the electrostatic spraying section P1 is viewed in the liquid composition discharge direction X, and there is no member that prevents the liquid composition discharged from the tip 16a from traveling through the air. As a result, with the apparatus 1 according to the present embodiment, it is possible to successfully form an intended coating even if the liquid composition is conveyed by the air flow and travels through the air.

From the viewpoint of more prominently exhibiting the advantageous effects of the apparatus 1 according to the present embodiment described above, it is desirable that the hollow section 22 sufficiently exhibits the function of temporarily storing the air flow generated in the air-flow generating section 21. From this viewpoint, in the hollow section 22, the value of V/F (min), which is the ratio of volume V (cm³) relative to flow rate F (cm³/min) of the air flow generated in the air-flow generating section 21, is preferably 0.001 min or more, more preferably 0.002 min or more, and even more preferably 0.005 min or more. Also, the value of V/F (min) is preferably 0.5 min or less, more preferably 0.2 min or less, and even more preferably 0.1 min or less. In particular, the value of V/F (min) is preferably 0.001 min or more and 0.5 min or less, more preferably 0.002 min or more and 0.2 min or less, and even more preferably 0.005 min or more and 0.1 min or less.

Although a preferred range of the value of V/F (min) has been given above, the value of volume V of the hollow section 22 is preferably 10 cm³ or more and 1000 cm³ or less, more preferably 20 cm³ or more and 500 cm³ or less, and even more preferably 30 cm³ or more and 100 cm³ or less. On the other hand, the value of flow rate F of the air flow is preferably 100 cm³/min or more and 50000 cm³/min or less, more preferably 250 cm³/min or more and 30000 cm³/min or less, and even more preferably 500 cm³/min or more and 20000 cm³/min or less. The volume V of the hollow section 22 is equal to the volume of the internal space of the cylindrical body 25 that defines the hollow section 22 in the case where there is no other member in the hollow section 22. In the case where there is another member in the hollow section 22, the volume V of the hollow section 22 is a value obtained by subtracting the volume of the member from the volume of the internal space of the cylindrical body 25.

In the apparatus 1 according to the present embodiment, the liquid composition flow path through which the liquid composition reaches the tip 16a of the nozzle 16 via the electrode 20 is included in the nozzle 16. The housing 10 that constitutes a portion of the apparatus 1 includes the pipeline 17 that includes the liquid composition flow path. As shown in FIG. 1, the pipeline 17 is disposed in the hollow section 22. In order for the hollow section 22 to sufficiently exhibit the function of temporarily storing the air flow, it is desirable that, as far as possible, there is no other member in the internal space of the cylindrical body 25 that defines the hollow section 22. From this viewpoint, it is advantageous that the outer circumference of the pipeline 17 is surrounded by the space that constitutes the hollow section 22, and the hollow section 22 is located on the rear side of the pipeline 17. As a result of the pipeline 17 being disposed in the hollow section 22 as described above, the air flow smoothly passes through the hollow section 22, and the air flow is jetted uniformly from the air jetting openings 24.

From another viewpoint of sufficiently exhibiting the function of temporarily storing the air flow by the hollow section 22, when the transverse cross sectional area of the outer edge of the hollow section 22 in a direction perpendicular to the direction of the air flow generated in the air-flow generating section 21 (the direction being the same direction as the liquid composition discharge direction X), or in other words, the transverse cross sectional area of the inner wall of the cylindrical body 25 is compared between different positions in the discharge direction X, it is preferable that the difference in the transverse cross sectional area is small. The value of Q2/Q1, which is the ratio of the Q2 relative to the Q1, is preferably 70% or more, more preferably 80% or more, and even more preferably 85% or more. The Q2 represents an average value of transverse cross sectional areas of the outer edge of the hollow section 22 at positions other than a position adjacent to the air-flow generating section 21, and the Q1 represents a transverse cross sectional area at the position adjacent to the air-flow generating section 21 Also, the ratio is preferably 120% or less, more preferably 110% or less, and even more preferably 105% or less. As used herein, the outer edge of the hollow section 22 means the outer edge of the space that forms the hollow section 22. The transverse cross sectional area of the outer edge is calculated based on, for example, in the case where a connection portion for a tube, a power supply cord, or the like is provided in a portion of the hollow section 22, the transverse cross section of the outer edge of the hollow section excluding the connection portion. The air-flow generating section 21 is a region in which, for example, a fan is provided, and the position of the hollow section 22 at a position adjacent to the air-flow generating section 21 is referred to as a fan-side end portion of a cylindrical section that is adjacent to the region in which the fan is provided.

From the viewpoint of temporarily storing the air flow generated in the air-flow generating section 21 in the hollow section 22, the average value (Q3) of transverse cross sectional areas of the air-flow generating section 21 taken along a direction perpendicular to the direction of the air flow generated in the air-flow generating section 21 (the direction being the same direction as the liquid composition discharge direction X) is preferably slightly larger than, or about the same as, the transverse cross sectional area (Q1) of the outer edge of the hollow section 22 at the position adjacent to the air-flow generating section 21 because the air-flow generating section 21 is internally provided with a fan or the like. For example, the value of Q3/Q1, which is the ratio of the transverse cross sectional area, is preferably 80% or more, and more preferably 90% or more, and preferably 170% or less, and more preferably 150% or less.

In relation to the ratios described above, Q1, Q2, and Q3 are each independently preferably 5 cm² or more and 30 cm² or less, more preferably 7 cm² or more and 25 cm² or less, and even more preferably 7 cm² or more and 20 cm² or less.

As described above, the hollow section 22 defined by the cylindrical body 25 is preferably adjacent to the air jetting openings 24. With this configuration, the air flow that has passed through the hollow section 22 is smoothly jetted from the air jetting openings 24. From the viewpoint of more prominently exhibiting this advantageous effect, the length of the air jetting openings 24 in the air flow direction is preferably 10 mm or less, more preferably 8 mm or less, and even more preferably 6 mm or less. There is no particular limitation on the lower limit value of the length, but the lower limit value of the length may be set to, for example, preferably 0.1 mm or more, or more preferably 0.5 mm or more. If the length of the air jetting openings 24 is as short as about 2 mm, the air flow can be jetted sufficiently smoothly from the air jetting openings 24.

From the viewpoint of jetting the air flow at high speed from the air jetting openings 24 due to the principle of orifice described above, the proportion of the total area of the air jetting openings 24 relative to the above-described transverse cross sectional area (Q1) of the outer edge of the hollow section 22 at the position adjacent to the air-flow generating section 21 (hereinafter, the proportion will be referred to as “jetting opening area proportion”) is preferably 1.5% or more, more preferably 3% or more, and even more preferably 5% or more. Also, the jetting opening area proportion is preferably 70% or less, more preferably 50% or less, and even more preferably 30% or less. Specifically, the jetting opening area proportion is preferably 1.5% or more and 70% or less, more preferably 3% or more and 50% or less, and even more preferably 5% or more and 30% or less.

The apparatus 1 is configured such that the amount of air flow jetted from the air jetting opening 24 is adjusted to preferably 100 cm³/min or more, more preferably 250 cm³/min or more, and even more preferably 500 cm³/min or more. Also, the apparatus 1 is configured such that the amount of air flow jetted from the air jetting opening 24 is adjusted to preferably 50000 cm³/min or less, more preferably 30000 cm³/min or less, and even more preferably 20000 cm³/min or less. In particular, the apparatus 1 is configured such that the amount of air flow jetted from the air jetting opening 24 is adjusted to preferably 100 cm³/min or more and 50000 cm³/min or less, more preferably 250 cm³/min or more and 30000 cm³/min or less, and even more preferably 500 cm³/min or more and 20000 cm³/min or less. In the case where only one air jetting opening 24 is provided, the above-described values indicate the amount of air flow jetted from the air jetting opening 24, and in the case where a plurality of air jetting openings 24 are provided, the above-described values indicate the total amount of air flows jetted from all of the air jetting openings 24.

When the amount of air flow jetted from the air jetting opening 24 is within the above-described range, from the viewpoint of successfully forming an intended coating, the apparatus 1 is configured such that the amount of liquid composition discharged from the nozzle 16 is adjusted to preferably 0.01 g/min or more, more preferably 0.05 g/min or more, and even more preferably 0.1 g/min or more. Also, the apparatus 1 is configured such that the amount of liquid composition discharged from the nozzle 16 is adjusted to preferably 2 g/min or less, more preferably 1.5 g/min or less, even more preferably 1.0 g/min or less, and even much more preferably 0.8 g/min or less. In particular, the apparatus 1 is configured such that the amount of liquid composition discharged from the nozzle 16 is adjusted to preferably 0.01 g/min or more and 2 g/min or less, more preferably 0.05 g/min or more and 1.5 g/min or less, even more preferably 0.1 g/min or more and 1.0 g/min or less, and even much more preferably 0.1 g/min or more and 0.8 g/min or less.

From the viewpoint of successfully forming an intended coating, the apparatus 1 is configured such that the voltage applied to the liquid composition when discharging the liquid composition from the nozzle 16 is adjusted to preferably 1 kV or more, more preferably 5 kV or more, and even more preferably 10 kV or more. Also, the apparatus 1 is configured such that the voltage is adjusted to preferably 40 kV or less, more preferably 30 kV or less, even more preferably 25 kV or less, and even much more preferably 20 kV or less. In particular, the apparatus 1 is configured such that the voltage applied to the liquid composition is adjusted to preferably 1 kV or more and 40 kV or less, more preferably 5 kV or more and 30 kV or less, even more preferably 10 kV or more and 25 kV or less, and even much more preferably 10 kV or more and 20 kV or less.

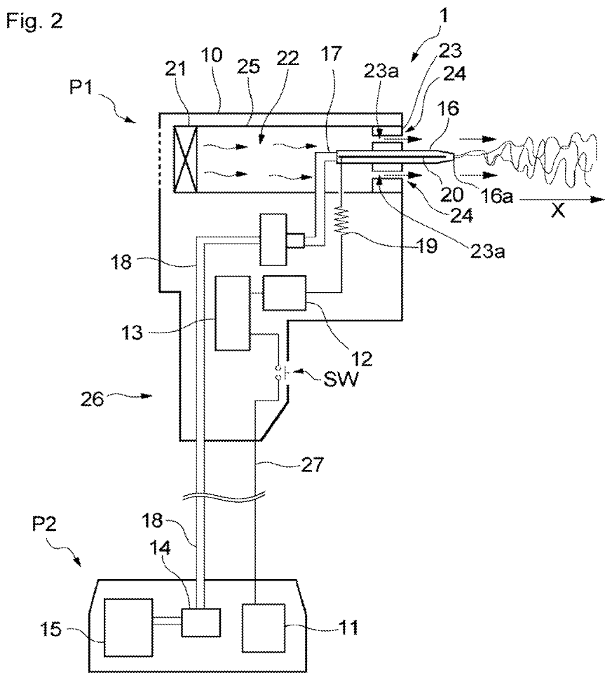

FIG. 2 shows another embodiment of the apparatus for producing a coating according to the present invention. Regarding the points that are not described specifically in the present embodiment, the above detailed description of the embodiment shown in FIG. 1 is applicable. Also, in FIG. 2, members that are the same as those shown in FIG. 1 are given the same reference numerals. The apparatus 1 according to the embodiment shown in FIG. 2 is roughly divided into an electrostatic spraying section P1 and a stationary accommodating section P2. The two sections are provided separately. In the embodiment shown in FIG. 1 described above, the electrostatic spraying section P1 itself serves as the apparatus 1, but in the present embodiment, among the members that constitute the electrostatic spraying section P1 of the embodiment shown in FIG. 1, a low voltage power supply 11 that applies voltage to an electrode 20, a container 15 that can contain a liquid composition, and a pump 14 that is a liquid transmitting section that supplies the liquid composition to a nozzle 16 are accommodated in the stationary accommodating section P2. The electrostatic spraying section P1 and the stationary accommodating section P2 are connected by a pipeline 18 that transmits the liquid composition and an electric wire 27 that electrically connects the electrode 20 and the low voltage power supply 11. The electrostatic spraying section P1 has dimensions and/or a shape that a human can hold with one hand. According to the present embodiment, the liquid composition can be discharged over a long period of time without impairing the ease of handling of the electrostatic spraying section P1, and a coating with a large area can be easily formed.

In the embodiment shown in FIG. 2, the pipeline 18 and the electric wire 27 that connect the electrostatic spraying section P1 and the stationary accommodating section P2 are independently provided. However, taking into consideration the ease of handling of the electrostatic spraying section P1, the pipeline 18 and the electric wire 27 may be combined into one cable.

With the use of the apparatus for producing a coating of each of the embodiments described above, according to the present invention, by electrostatically spraying a liquid composition that contains a fiber-forming polymer directly to a surface of an object while jetting an air flow from an air jetting opening, a coating made of deposits of fibers can be formed on the surface of the object.

The liquid composition used in each of the embodiments described above contains a polymer that is capable of forming fibers. Also, the liquid composition preferably contains one or two or more volatile substances selected from water, alcohol, and ketone.

The volatile substance is a substance that is volatile in a liquid state. The volatile substance is contained in the liquid composition for the following purpose. The liquid composition placed in the electric field is, after sufficiently electrically charged, discharged from the tip 16a of the nozzle 16 toward the skin. As the volatile substance evaporates, the electric charge density of the liquid composition becomes excessive, the volatile substance further evaporates during which the polymer is formed into fine fibers due to Coulomb repulsion, and finally fibers are formed. For this purpose, the vapor pressure of the volatile substance at 20° C. is preferably 0.01 kPa or more and 106.66 kPa or less, more preferably 0.13 kPa or more and 66.66 kPa or less, even more preferably 0.67 kPa or more and 40.00 kPa or less, and even much more preferably 1.33 kPa or more and 40.00 kPa or less.

As the alcohol used as the volatile substance, for example, a monovalent chain aliphatic alcohol with 1 to 6 carbon atoms, a monovalent cyclic aliphatic alcohol with 3 to 6 carbon atoms, or a monovalent aromatic alcohol is preferably used. Specific examples thereof include ethanol, isopropyl alcohol, butyl alcohol, phenylethyl alcohol, propanol, pentanol, and the like. As the alcohol, one or two or more selected from these alcohols can be used.

As the ketone used as the volatile substance, for example, a chain aliphatic ketone with 3 to 6 carbon atoms, a cyclic aliphatic ketone with 3 to 6 carbon atoms, or an aromatic ketone with 8 to 10 carbon atoms is preferably used. Specific examples thereof include acetone, methyl ethyl ketone, methyl isobutyl ketone, cyclohexanone, acetophenone, and the like. The ketones can be used alone or in a combination of two or more.

As the water used as the volatile substance, ion exchanged water, purified water, or distilled water is preferably used. With water being contained in the liquid composition, the electroconductivity of the liquid composition can be increased by electrolytic dissociation of water. As a result of the liquid composition having high electroconductivity, when electrostatically spraying is carried out, a fibrous coating can be formed on the surface of an application site such as the skin in a stable manner. Also, water contributes to an improvement in adhesion of the coating to the skin or the like, the coating being a coating formed by electrostatically spraying.

The volatile substance contains preferably one or two or more selected from ethanol, isopropyl alcohol, butyl alcohol, and water, more preferably one or two or more selected from water, ethanol, and butyl alcohol, and even more preferably water and ethanol.

From the viewpoint of dispersibility of the fiber-forming polymer that is used together with the volatile substance and from the viewpoint of applying electric charges, the volatile substance is preferably a mixed solution of: (a) one or two or more selected from ethanol, isopropyl alcohol, and butyl alcohol; and (b) water. The value of (b)/(a), which is the mass ratio between (a) and (b), is preferably 0.0025 or more and 1 or less, and more preferably 0.0025 or more and 0.85 or less from the viewpoint of formability of fibers and adhesion of the coating. In the case where the fiber-forming polymer contains a water insoluble polymer in an amount of 50 mass % or more, the value of (b)/(a), which is the mass ratio between component (a) and component (b), is preferably 0.0025 or more and 0.3 or less, and more preferably 0.0025 or more and 0.2 or less from the viewpoint of formability of fibers and adhesion of the coating.

From the viewpoint of further improving the formability of fibers and the adhesion of the coating, the amount of water contained in the liquid composition is preferably 0.2 mass % or more and 45 mass % or less, and more preferably 0.3 mass % or more and 40 mass % or less. In the case where the fiber-forming polymer contains a water insoluble polymer, the amount of water contained in the liquid composition is preferably 0.2 mass % or more and 25 mass % or less, more preferably 0.3 mass % or more and 20 mass % or less, even more preferably 0.35 mass % or more and 19 mass % or less, and even much more preferably 0.4 mass % or more and 18 mass % or less.

The fiber-forming polymer that is used together with the volatile substance is generally a substance that can be dissolved in the volatile substance. The term “dissolve” as used herein refers to a state in which a substance is in a dispersed state at 20° C. and the dispersion is uniform when visually observed, and preferably transparent or translucent when visually observed.

As the fiber-forming polymer, a polymer is used that is appropriate according to the properties of the volatile substance. Specifically, fiber-forming polymers are roughly classified into water-soluble polymers and water-insoluble polymers. The term “water-soluble polymer” as used herein refers to a polymer having a property such that when 1 g of the polymer is weighed out and immersed in 10 g of ion exchanged water in an environment at a pressure of 1 atmosphere and a temperature of 23° C. for 24 hours, 0.5 g or more of the immersed polymer dissolves in the water. On the other hand, the term “water-insoluble polymer” as used herein refers to a polymer having a property such that when 1 g of the polymer is weighed out and immersed in 10 g of ion exchanged water in an environment at a pressure of 1 atmosphere and a temperature of 23° C. for 24 hours, more than 0.5 g of the immersed polymer does not dissolve in the water.

Examples of the fiber-forming polymers that are water-soluble include: naturally-occurring macromolecules such as pullulan, hyaluronic acid, chondroitin sulfate, poly-γ-glutamic acid, modified corn starch, β-glucan, glucooligosaccharide, heparin, mucopolysaccharide such as keratosulfate, cellulose, pectin, xylan, chitosan, lignin, glucomannan, galacturonic acid, psyllium seed gum, tamarind seed gum, gum arabic, gum traganth, water-soluble soybean polysaccharide, alginic acid, carrageenan, laminaran, agar (agarose), fucoidan, methyl cellulose, hydroxypropyl cellulose, and hydroxypropyl methyl cellulose; and synthetic macromolecules such as partially saponified polyvinyl alcohol (when not used in a combination with a cross-linking agent), low saponified polyvinyl alcohol, polyvinyl pyrrolidone (PVP), polyethylene oxide, sodium polyacrylate, a water-soluble polyamide resin such as water-soluble nylon, and a water-soluble polyurethane resin. One water-soluble polymer selected from these water-soluble polymers can be used alone, or two or more water-soluble polymers selected therefrom can be used in combination. It is preferable to use pullulan and synthetic macromolecules such as partially saponified polyvinyl alcohol, low saponified polyvinyl alcohol, polyvinyl pyrrolidone, chitosan, a water-soluble polyamide resin, a water-soluble polyurethane resin, and polyethylene oxide, of these water-soluble polymers, from the viewpoint of forming a coating with ease. When polyethylene oxide is used as the water-soluble polymer, its number average molecular weight is preferably 50000 or more and 3000000 or less, and more preferably 100000 or more and 2500000 or less.

On the other hand, examples of the fiber-forming polymers that are water-insoluble include: completely saponified polyvinyl alcohol, which can be insolubilized after formation of fibers; partially saponified polyvinyl alcohol, which can be cross-linked after formation of fibers when used in a combination with a cross-linking agent; oxazoline modified silicone such as a poly(N-propanoylethyleneimine)-grafted dimethylsiloxane/γ-aminopropylmethylsiloxane copolymer; polyvinylacetal diethylamino acetate; zein (main component of corn proteins); polyester; polylactic acid (PLA); an acrylic resin such as a polyacrylonitrile resin and a polymethacrylic acid resin; a polystyrene resin; a polyvinyl butyral resin; a polyethylene terephthalate resin; a polybutylene terephthalate resin; a polyurethane resin; a polyamide resin; a polyimide resin; and a polyamideimide resin. In the present invention, one water-insoluble polymer selected from these water-insoluble polymers can be used alone, or two or more water-insoluble polymers selected therefrom can be used in combination. It is preferable to use completely saponified polyvinyl alcohol, which can be insolubilized after formation of fibers, partially saponified polyvinyl alcohol, which can be cross-linked after formation of fibers when used in a combination with a cross-linking agent, a polyvinyl butyral resin, a polymethacrylic acid resin, polyvinylacetal diethylamino acetate, oxazoline modified silicone such as a poly(N-propanoylethyleneimine)-grafted dimethylsiloxane/γ-aminopropylmethylsiloxane copolymer, a polyurethane resin, a polyamide resin, polylactic acid, zein, and the like, of these water-insoluble polymers.

The amount of volatile substance contained in the liquid composition is preferably 50 mass % or more and 95 mass % or less, more preferably 55 mass % or more and 94 mass % or less, even more preferably 60 mass % or more and 93 mass % or less, and even much more preferably 65 mass % or more 92 mass % or less. When the volatile substance is blended into the liquid composition in the above-described proportion, the liquid composition can sufficiently volatilize when the electrostatic spraying method is performed.

On the other hand, the amount of fiber-forming polymer contained in the liquid composition is preferably 2 mass % or more and 35 mass % or less, more preferably 3 mass % or more and 30 mass % or less, and even more preferably 5 mass % or more and 25 mass % or less. When the fiber-forming polymer is blended into the liquid composition in the above-described proportion, it is possible to successfully form an intended coating.

When forming deposits of fibers using the apparatus 1 of the present embodiment, the thickness of the fibers expressed as a diameter of a corresponding circle is preferably 10 nm or more, and more preferably 50 nm or more. In addition, the thickness is preferably 3000 nm or less, and more preferably 1000 nm or less. The thickness of the fibers can be measured by observing the fibers magnified 10000 times using a scanning electron microscope (SEM), for example, removing defects (mass of fibers, intersection of fibers, and droplets) from the two-dimensional images of the fibers, selecting any ten fibers, drawing a line orthogonal to the longitudinal direction of each of the fibers, and reading the diameter of the fiber directly.

Although each of the fibers is a continuous fiber with an infinite length in the formation principle, it is preferable that the fiber has a length at least 100 times longer than its thickness. In this description, a fiber having a length over 100 times than its thickness is defined as a “continuous fiber”. It is preferable that a coating that is formed using the apparatus 1 of the present embodiment is a porous discontinuous coating made of deposits of continuous fibers. The coating in such a form can be treated as one sheet composed of an aggregate and has the property of being very soft, and therefore, the coating is unlikely to fall apart even when a shearing force is applied to the coating.

When forming a coating using the apparatus 1 according to the present embodiment, from the viewpoint of successfully forming the coating, the distance between the nozzle 16 and the application site is, although it depends on the voltage applied to the nozzle 16, preferably 10 mm or more, more preferably 20 mm or more, even more preferably 40 mm or more, and even much more preferably 60 mm or more. Also, the distance between the nozzle 16 and the application site is preferably 300 mm or less, more preferably 250 mm or less, even more preferably 200 mm or less, and even much more preferably 150 mm or less. More specifically, the distance between the nozzle 16 and the application site is preferably 10 mm or more and 300 mm or less, more preferably 20 mm or more and 250 mm or less, even more preferably 40 mm or more and 200 mm or less, and even much more preferably 60 mm or more and 150 mm or less. The distance between the nozzle and the application site can be measured using a commonly used non-contact sensor or the like.

Irrespective of whether the coating formed by the apparatus 1 according to the present embodiment is porous or not, the basis weight of the coating per 1 m² of the skin is preferably 0.05 g/m² or more, more preferably 0.1 g/m² or more, and even more preferably 1 g/m² or more. Also, the basis weight is preferably 50 g/m² or less, more preferably 40 g/m² or less, even more preferably 30 g/m² or less, even much more preferably 25 g/m² or less, and yet even much more preferably 20 g/m² or less. For example, the basis weight of the coating per 1 m² of the skin is preferably 0.05 g/m² or more and 50 g/m² or less, more preferably 0.1 g/m² or more and 40 g/m² or less, even more preferably 0.1 g/m² or more and 30 g/m² or less, even much more preferably 0.1 g/m² or more and 25 g/m² or less, and yet even much more preferably 1 g/m² or more and 20 g/m² or less. By setting the basis weight of the coating in the above-described range, it is possible to effectively prevent peeling of the coating caused by the coating becoming too thick.

Up to here, the present invention has been described by way of preferred embodiments thereof. However, the present invention is not limited to the embodiments described above. For example, the electrostatic spraying section P1 used in each of the embodiments described above is configured as a hand-held electrostatic spraying section, but instead, it may be configured as a large-sized stationary electrostatic spraying section P1.

### EXAMPLES

Hereinafter, the present invention will be described in further detail by way of examples. However, the scope of the present invention is not limited to the examples given below. Unless otherwise stated, the percent sign “%” used herein means “mass %”.

### Example 1

### (1) Preparation of Liquid Composition

A liquid composition containing 99.5% ethanol (0.5% water) in an amount of 88% and polyvinyl butyral in an amount of 12% was prepared. As the polyvinyl butyral, S-LEC B BM-1 (product name) available from Sekisui Chemical Co., Ltd. was used.

### (2) Preparation of Apparatus For Producing Coating

An apparatus configured as shown in FIG. 1 was prepared. The volume of the hollow section 22 was 72 cm³ (the value obtained by subtracting the volume of the pipeline 17), and the flow rate of air flow generated in the air-flow generating section 21 was 750 cm³/min. The cylindrical body 25 constituting the hollow section 22 had a cylindrical shape. The diameter thereof was 32 mm and the transverse cross sectional area Q1 thereof was 8.04 cm². Also, the transverse cross sectional area Q2 was 7.1 cm² (average diameter: 30 mm), and Q3 was 11.3 cm². Eight circular air jetting openings 24 were provided, and the length of each the short flow path 23a in the air flow direction was set to 6 mm. The jetting opening area proportion, which was described above, was 6.2%.

### (3) Formation of Coating Made of Deposits of Fibers

The amount of liquid composition discharged from the nozzle 16 was set to 0.12 g/min, the amount of air jetted from the air jetting openings 24 was set to 750 cm³/min, and the voltage applied to the electrode 20 was set to 10 kV. Under the conditions described above, a coating made of deposits of fibers was formed on a surface of a collector plate made of polyoxymethylene using an electrospinning method. The distance between the tip 16a of the nozzle 16 and the collector plate was set to 100 mm. The surrounding environment in which the electrospinning method was carried out was set to 30° C. and 70% RH.

### Examples 2 to 4, and Comparative Examples 1 and 2

Coatings made of deposits of fibers were formed in the same manner as in Example 1, except that the amount of air jetted from the air jetting openings 24 and the surrounding environment were set to values shown in Table 1 given below.

### Evaluation

Each of the coatings obtained in Examples and Comparative Examples was visually observed to check the state of the coating, and evaluated based on the following scale. The results are shown in Table 1.

### Evaluation Scale For Coating

A: a coating whose adhesion to the skin was high and good was formed.

B: formation of a coating was unstable, and the adhesion of the coating to the skin was not uniform.

C: fibers returned to the production apparatus and deposited on the skin in an undried state, and droplets were produced.

TABLE 1

| | | Amount of air | Evaluation |
|---|---|---|---|
| | Surrounding | flow jetted | of |
| | environment | (cm³/min) | coating |
| Example 1 | 30° C. · | 750 | A |
| | 70% RH | | |
| Example 2 | 30° C. · | 3000 | A |
| | 70% RH | | |
| Example 3 | 30° C. · | 750 | A |
| | 90% RH | | |
| Example 4 | 30° C. · | 3000 | A |
| | 90% RH | | |
| Comparative | 30° C. · | 0 | B |
| Example 1 | 70% RH | | |
| Comparative | 30° C. · | 0 | C |
| Example 2 | 90% RH | | |

As can be clearly seen from the results shown in Table 1, the coatings obtained in Examples exhibited good adhesion to the collector plate, from which it can be seen that the unevenness of the adhesion of the coating to the skin was small. In contrast, the coatings obtained in Comparative Examples received the influence of the surrounding environment, and thus exhibited poor adhesion to the plate, from which it can be seen that the unevenness of the adhesion of the coating to the skin was large.

### INDUSTRIAL APPLICABILITY

As described above in detail, according to the present invention, it is possible to easily form a coating made of deposits of fibers. According to the present invention, for example, a uniform coating can be easily formed even in an environment in which it is not easy to perform control to maintain a constant temperature and a constant humidity.

1. An apparatus for producing a coating, wherein the apparatus is configured to electrostatically spray a liquid composition that comprises a fiber-forming polymer directly to a surface of an object so as to form a coating made of deposits of fibers on the surface of the object, and
the apparatus comprises an electrostatic spraying section that includes a housing,
wherein the housing is internally provided with:
a nozzle that discharges the liquid composition;
an electrode that applies voltage to the liquid composition that passes through the nozzle;
an air-flow generating section that is located on a rear side of the nozzle;
a hollow section that is located between the nozzle and the air-flow generating section and is adjacent to the air-flow generating section; and
an air jetting opening that is located around the nozzle and jets an air flow that has passed through the hollow section, and
the housing is configured to be capable of being held by a human hand.

2-19. (canceled)

20. The apparatus according to claim 1, wherein the object is human skin.

21. The apparatus according to claim 1,
wherein the housing includes a pipeline that has a liquid composition flow path through which the liquid composition reaches the tip of the nozzle via the electrode,
a portion of the pipeline is present in the hollow section,
the apparatus further comprises a container and a micro gear pump, and
the container where the liquid composition is to be contained is in communication with the nozzle via the micro gear pump.

22. The apparatus according to claim 1,
wherein the apparatus further comprises a high voltage power supply and an electric current limiting resistor, and
the electrode is electrically connected to the high voltage power supply via the electric current limiting resistor.

23. The apparatus according to claim 1,
wherein the hollow section is adjacent to the air jetting opening.

24. The apparatus according to claim 1,
wherein no member that extends in a direction perpendicular to an air flow direction and that divides the hollow section is provided between the hollow section and the air-flow generating section.

25. The apparatus according to claim 1,
wherein the hollow section has a function of temporarily storing the air flow by a value of V/F (min), which is a ratio of volume V (cm³) relative to flow rate F (cm³/min) of the air flow generated in the air-flow generating section, being set to 0.001 min or more and 0.5 min or less.

26. The apparatus according to claim 1,
wherein, when the electrostatic spraying section is viewed in a discharge direction of the liquid composition, a tip of the nozzle is located at a frontmost end portion of the electrostatic spraying section.

27. The apparatus according to claim 1,
wherein the housing includes a pipeline that has a liquid composition flow path through which the liquid composition reaches the tip of the nozzle via the electrode, and
a portion of the pipeline is present in the hollow section.

28. The apparatus according to claim 1,
wherein an outer circumference of the pipeline is surrounded by a space that constitutes the hollow section, and the hollow section is located on a rear side of the pipeline.

29. The apparatus according to claim 1,
wherein a length of the air jetting opening in a direction of the air flow is 10 mm or less.

30. The apparatus according to claim 1,
wherein the housing has dimensions and/or a shape that a human can hold with one hand.

31. The apparatus according to claim 1,
wherein the housing includes a handle that can be held by one human hand.

32. The apparatus according to claim 1,
wherein the apparatus is configured such that an amount of the liquid composition discharged is adjusted to 0.01 g/min or more and 2 g/min or less, and an amount of the air flow jetted from the air jetting opening is adjusted to 100 cm³/min or more and 50,000 cm³/min or less.

33. The apparatus according to claim 1,
wherein the apparatus is configured such that the voltage applied to the liquid composition by the electrode is 1 kV or more and 40 kV or less.

34. The apparatus according to claim 1, further comprising:
a stationary accommodating section that is provided separately from the electrostatic spraying section,
wherein the stationary accommodating section includes:
a container that can contain the liquid composition;
a liquid transmitting section that supplies the liquid composition to the nozzle; and
a power supply that applies voltage to the electrode, and
the electrostatic spraying section and the stationary accommodating section are connected by a pipeline that transmits the liquid composition and an electric wire that electrically connects the electrode and the power supply.

35. The apparatus according to claim 1,
wherein the hollow section is composed of one hollow section.

36. The apparatus according to claim 1,
wherein a volume of the hollow section is 10 cm³ or more and 1,000 cm³ or less.

37. The apparatus according to claim 1,
wherein the electrostatic spraying section is constituted by an electrospinning apparatus.

38. A method for producing a coating, the method comprising:
with use of the apparatus for producing a coating according to claim 1, electrostatically spraying a liquid composition that comprises a fiber-forming polymer directly to a surface of an object while jetting an air flow from the air jetting opening so as to form a coating made of deposits of fibers on the surface of the object.
